(19) United States
(12) Patent Application Publication
(10) Pub. No.: US 2011/0055887 A1
(43) Pub. Date: Mar. 3, 2011

(54) Tunneling and Signaling of Content in Legacy Formats

(75) Inventors: Jani Väre, Kaarina (FI); Jyrki Alamaunu, Turku (FI)

(73) Assignee: NOKIA CORPORATION, Espoo (FI)

(21) Appl. No.: 12/856,714

(22) Filed: Aug. 16, 2010

Related U.S. Application Data
(60) Provisional application No. 61/236,932, filed on Aug. 26, 2009.

(51) Int. Cl. H04N 7/173

(52) U.S. Cl. 725/116; 725/134

(57) ABSTRACT

Broadcast services and other transmissions may conform to multiple types of protocols. Accordingly, a broadcast system may tunnel broadcasts or transmissions of a first protocol in a transport stream conforming to a second protocol. Each of the tunneled streams may be multicast together and may correspond to a separate and different physical layer pipe. The types of protocols and physical layer pipes carried in the transport stream may be defined in a pre-signaling section and/or post-signaling section of the transport stream. Common physical layer pipes may be generated and included in the transport stream to carry information and data common to multiple broadcast services or transmissions such as program specific information or service information.

### CROSS REFERENCE TO RELATED APPLICATION

This application is a non-provisional application of and claims the benefit of priority from U.S. Provisional Patent Application No. 61/236,932, entitled “TUNNELING AND SIGNALING OF CONTENT IN LEGACY FORMATS,” and filed on Aug. 26, 2009, the content of which is incorporated herein by reference in its entirety.

### BACKGROUND

With the advent of new broadcast protocols, legacy devices might not be able to transmit or receive content or services conforming to the new protocols. For example, receivers might not understand the formatting of the new transmission protocol and thus, users may need to upgrade their hardware or firmware. Similarly, transmitters may need to be reconfigured to the new broadcast protocols. Content providers may also need to convert their content to the new broadcast protocol instead of the legacy formats used previously.

### BRIEF SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Aspects of the present disclosure relate to a system and method for tunneling legacy broadcast streams in a carrier stream. In one or more arrangements, the tunneled broadcast streams may include streams conforming to a first set of broadcast protocols while the carrier stream may conform to a second type of broadcast protocol. The first set of broadcast protocols may be legacy protocols. Each of the tunneled streams may be assigned to a physical layer pipe (PLP) within the carrier stream and have a corresponding broadcast protocol identified in a signaling section of the carrier stream. For example, the types of tunneled streams may be specified in a Layer 1 pre-signaling section (e.g., a TYPE field) while the particular PLPs corresponding to each of the tunneled streams may be defined in a Layer 1 post-signaling section (e.g., a PLP payload type parameter).

According to another aspect, program specific information/service information may be provided within each tunneled stream or in the carrier stream or both. In one example, service information may be stored in service descriptors of a service description table carried in a common PLP of the carrier stream. The service descriptors may include a service type parameter for which values may be defined for each of the various tunneled stream protocols. A common PLP may be accessed by all interested receivers regardless of which tunneled streams they are interested in. Thus, common PLP data may be applicable to all tunneled streams. Service information may correspond to both services currently available in the carrier stream and services that will be available in the future. A receiver may thus identify and save information for desired future services based on the service information transmitted in a currently available carrier stream.

### BRIEF DESCRIPTION OF THE DRAWINGS

Certain embodiments are illustrated by way of example and not limited in the accompanying figures in which like reference numerals indicate similar elements and in which:

FIG. 1 is a block diagram of an example content distribution network in which one or more embodiments may be implemented.

FIG. 2 is a block diagram of an example communication/receiving device according to one or more aspects described herein.

FIG. 3 illustrates an example DVB-T2/NGH broadcast network in which tunneled streams may be carried in a carrier stream according to one or more aspects described herein.

FIG. 4A illustrates an example DVB-T2 transport stream structure according to one or more aspects described herein.

FIG. 4B illustrates example L1 pre- and post-signaling sections and syntaxes thereof according to one or more aspects described herein.

FIG. 5 illustrates example L1 pre-signaling TYPE field values according to one or more aspects described herein.

FIG. 6 illustrates example L1 post-signaling PLP_PAYLOAD_TYPE field values according to one or more aspects described herein.

FIG. 7 illustrates program specific information/service information signaling for tunneled streams in a DVB-T2 transmission stream according to one or more aspects described herein.

FIG. 8 illustrates an example syntax for a service descriptor defining service information according to one or more aspects described herein.

FIG. 9 illustrates a table of service type values that may be used for a service descriptor according to one or more aspects described herein.

FIG. 10 illustrates an example syntax for a network information table according to one or more aspects described herein.

FIG. 11 is a flowchart illustrating an exemplary method for tunneling broadcast streams in a carrier stream according to one or more aspects described herein.

FIG. 12 illustrates a network environment in which a DVB-T2 transceiver is configured to distribute tunneled streams to compatible receiving devices according to one or more aspects described herein.

FIG. 13 illustrates a network environment in which a DVB-T2 transceiver is configured to distribute services over Internet Protocol according to one or more aspects described herein.

FIG. 14 illustrates an exemplary method by which a DVB-T2 transceiver may process a DVB-T2 carrier signal in which one or more streams are tunneled according to one or more aspects described herein.

### DETAILED DESCRIPTION

In the following description of the various embodiments, reference is made to the accompanying drawings, which form a part hereof, and in which are shown by way of illustration various embodiments in which the invention may be practiced. It is to be understood that other embodiments may be utilized and structural and functional modifications may be made without departing from the scope of the present invention.

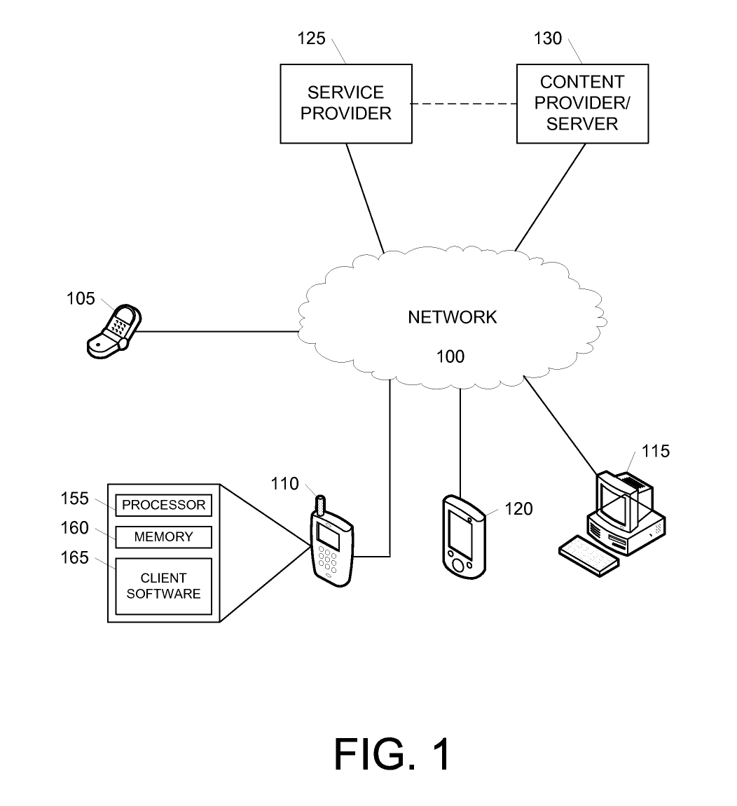

FIG. 1 illustrates an example communication network through which various inventive principles may be practiced. A number of computers and devices including mobile communication device 105, mobile phone 110, personal digital assistant (PDA) or mobile computer 120, personal computer (PC) 115, service provider 125 and content provider 130 may communicate with one another and with other devices through network 100. Network 100 may include wired and wireless connections and network elements, and connections over the network may include permanent or temporary connections. Communication through network 100 is not limited to the illustrated devices and may include additional mobile or fixed devices such as a video storage system, an audio/video player, a digital camera/camcorder, a positioning device such as a GPS (Global Positioning System) device or satellite, a television, an audio/video player, a radio broadcasting receiver, a set-top box (STB), a digital video recorder, remote control devices and any combination thereof.

Although shown as a single network in FIG. 1 for simplicity, network 100 may include multiple networks that are interlinked so as to provide internetworked communications. Such networks may include one or more private or public packet-switched networks, e.g. the public Internet and/or private networks utilizing Internet Protocol (IP), one or more private or public circuit-switched networks, e.g., a public switched telephone network, a cellular network configured to facilitate communications to and from mobile communication devices 105 and 110, e.g. through use of base stations, mobile switching centers, etc., a short or medium range wireless communication connection, e.g. Bluetooth®, ultra wideband (UWB), infrared, WiBree, wireless local area network (WLAN) according to one or more versions of Institute of Electrical and Electronics Engineers (IEEE) standard no. 802.11, or a high-speed wireless data network such as Evolution-Data Optimized (EV-DO) networks, Universal Mobile Telecommunications System (UMTS) networks, Long Term Evolution (LTE) networks or Enhanced Data rates for GSM Evolution (EDGE) networks. Devices 105-120 may use various communication protocols such as Internet Protocol (IP), Transmission Control Protocol (TCP), Simple Mail Transfer Protocol (SMTP) among others known in the art. Various messaging services such as Short Messaging Service (SMS) and/or Multimedia Message Service (MMS) may also be included.

Devices 105-120 may be configured to interact with each other or other devices, such as content server 130 or service provider 125. In one example, mobile device 110 may include client software 165 that is configured to coordinate the transmission and reception of information to and from content provider/server 130. In one arrangement, client software 165 may include application or server specific protocols for requesting and receiving content from content server 130. For example, client software 165 may comprise a Web browser or mobile variants thereof and content provider/server 130 may comprise a web server. Billing services (not shown) may also be included to charge access or data fees for services rendered. In one arrangement where service provider 125 provides cellular network access, e.g. acts as a wireless service provider, client software 165 may include instructions for access and communication through the cellular network. Client software 165 may be stored in computer-readable memory 160 such as read only, random access memory, writeable and rewriteable media and removable media in device 110 and may include instructions that cause one or more components—e.g., processor 155, a transceiver, and a display—of device 110 to perform various functions and methods including those described herein.

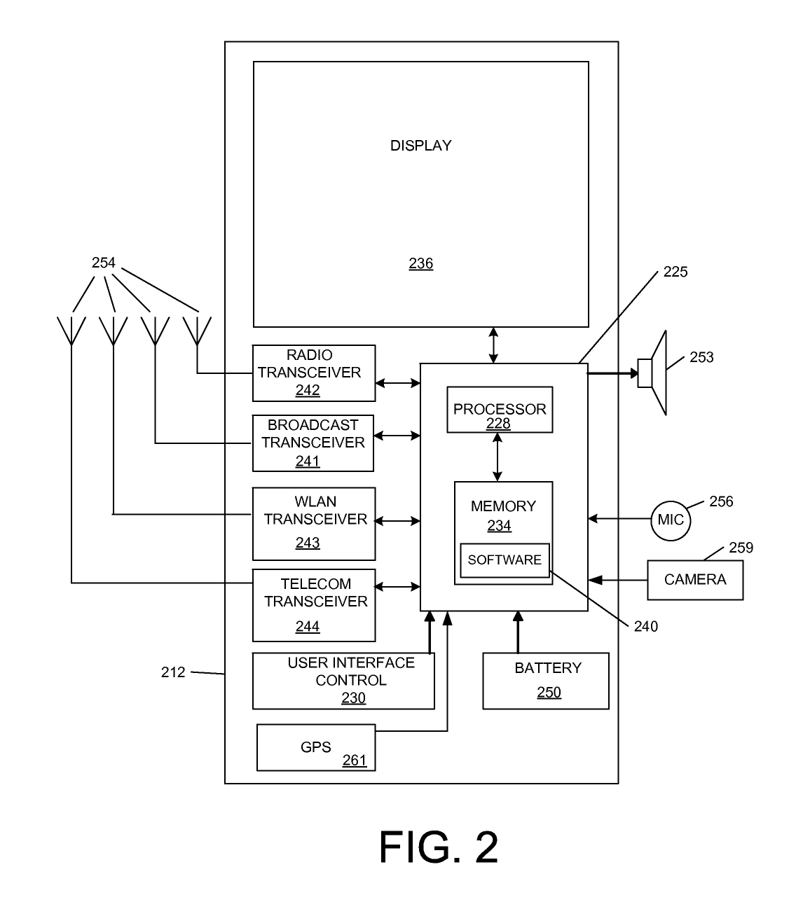

FIG. 2 illustrates an example computing device—mobile device 212—that may be used in network 100 of FIG. 1. Mobile device 212 may include a controller 225 connected to a user interface control 230, display 236 and other elements as illustrated. Controller 225 may include one or more processors 228 and memory 234 storing software 240, e.g. client software 165. Mobile device 212 may also include a battery 250, speaker 253 and antenna 254. The antenna may be a dedicated or a shared antenna per transceiver or transceiver groups. User interface control 230 may include controllers or adapters configured to receive input from or provide output to a camera 259, keypad, touch screen, voice interface (e.g. via microphone 256), function keys, joystick, data glove, mouse and the like. Additionally or alternatively, camera 259 and microphone 256 may be configured to capture various types of content including video, audio and still images.

Computer executable instructions and data used by processor 228 and other components of mobile device 212 may be stored in a storage facility such as memory 234. Memory 234 may comprise any type or combination of read only memory (ROM) modules or random access memory (RAM) modules, including both volatile and nonvolatile memory such as disks. Software 240 may be stored within memory 234 to provide instructions to processor 228 such that when the instructions are executed, processor 228, mobile device 212 and/or other components of mobile device 212 are caused to perform various functions or methods such as those described herein. Software may include both applications and operating system software, and may include code segments, instructions, applets, pre-compiled code, compiled code, computer programs, program modules, engines, program logic, and combinations thereof. Computer executable instructions and data may further be stored on computer readable media including electrically erasable programmable read-only memory (EEPROM), flash memory or other memory technology, CD-ROM, DVD or other optical disk storage, magnetic cassettes, magnetic tape, magnetic storage and the like. Some or all of the instructions implemented by processor 228 or other components so as to carry out the operations described herein may also be stored as hard-wired instructions (e.g., logic gates). For example, processor 228 could include one or more application specific integrated circuits (ASICs) configured to carry out operations such as those described herein.

Mobile device 212 or its various components may be configured to transmit and/or receive, decode and process various types of transmissions including digital broadband broadcast transmissions that are based, for example, on one or more Digital Video Broadcast (DVB) standards, such as Digital Video Broadcast—Handheld (DVB-H), Digital Video Broadcast—Terrestrial (DVB-T), Digital Video Broadcast—Second Generation Terrestrial (DVB-T2), Digital Video Broadcast—Next Generation Terrestrial (DVB-NGH), Digital Video Broadcast—Cable (DVB-C), Digital Video Broadcast—Second Generation Cable (DVB-C2), Digital Video Broadcast—Satellite (DVB-S), Digital Video Broadcast—Second Generation Satellite (DVB-S2) or Digital Video Broadcast—Multimedia Home Platform (DVB-MHP), through a specific broadcast transceiver 241. Other digital transmission formats may alternatively be used to deliver content and information regarding availability of supplemental services. Additionally or alternatively, mobile device 212 may be configured to receive, decode and process transmissions through FM/AM Radio transceiver 242, wireless local area network (WLAN) transceiver 243, and telecommunications transceiver 244. Transceivers 241, 242, 243 and 244 may, alternatively, include individual transmitter and receiver components. In one or more arrangements, mobile device 212 may further include a gyroscopic sensor (not shown) configured to determine an orientation of mobile device 212. According to one or more further aspects, mobile device 212 may include a GPS device for receiving and determining location information from one or more GPS satellites.

Although the above description of FIG. 2 generally relates to a mobile device, other apparatuses or devices or systems may include the same or similar components and perform the same or similar functions and methods. For example, a stationary computer such as PC 115 (FIG. 1) may include the components or a subset of the components described above and may be configured to perform the same or similar functions as mobile device 212 and its components. Other example apparatuses that may include one or more of the components illustrated in FIG. 2 include terminal devices, televisions, displays, set-top boxes, set-top units or routers. For example, a router may be configured to receive digital broadcasts using a transceiver such as transceiver 241 and to route the data to a display device or other computing device such as PC 115 or mobile device 212, a set-top box (not shown) a television display and the like. Such apparatuses may include dedicated processors such as video encoders or decoders in a display device or general processors such as those used in general computing systems. Additional or alternative components may also be included in apparatuses configured according to aspects described herein.

Broadcast video content may be received by mobile device 212 (FIG. 2) or PC 115 (FIG. 1) through a broadcast receiver such as transceiver 241 (FIG. 2). In some instances, mobile device 212 or PC 115 might not be compatible with the most recent broadcast receiving protocols. Accordingly, a content broadcaster may wish to provide content in legacy formats to insure that most, if not all, receivers are able to receive and view the content. In one example, the content broadcast may provide content in legacy formats by tunneling the legacy content transport streams through a transport stream conforming to the newer or non-compatible broadcast protocol. Other types of streams may also be tunneled including packetized elementary streams (PES), program streams, service information streams and the like. By tunneling the legacy transport streams or other types of streams, content provided in the legacy streams may be delivered to a receiver in a transparent manner. That is, a receiver would not need to understand or process the newer or non-compatible broadcast protocol.

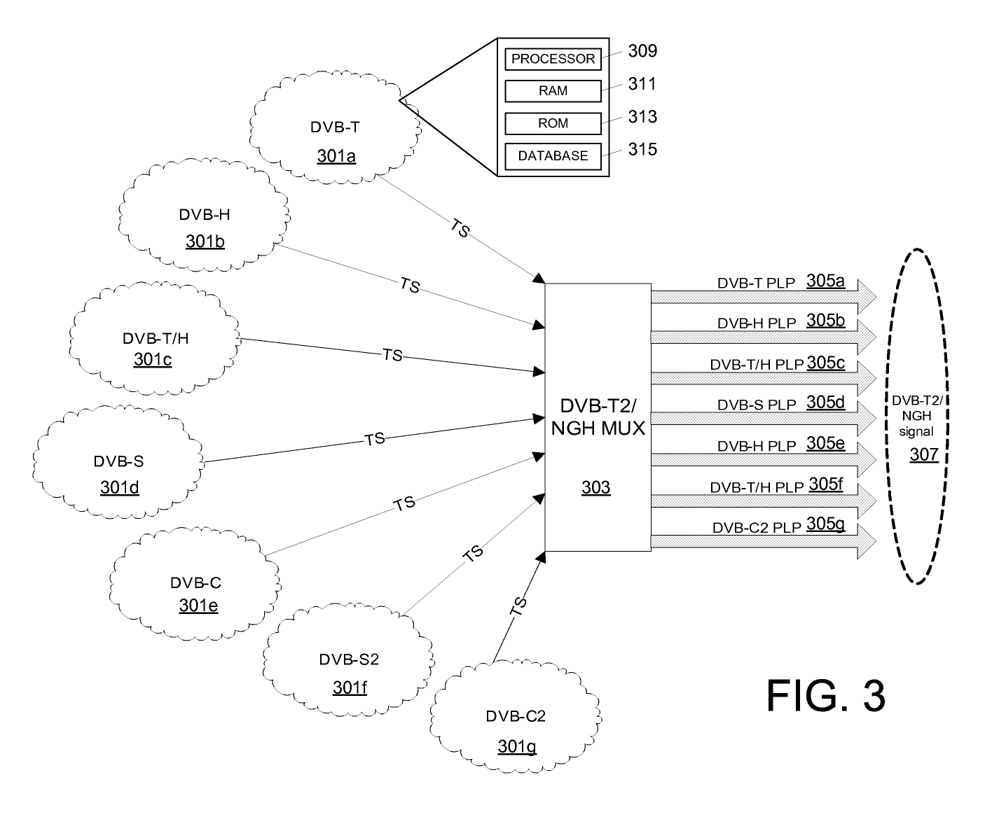

FIG. 3 illustrates a broadcast network through which multiple types of broadcast transmissions may be tunneled through a carrier transport stream formatted according to a non-receiver compatible transport protocol. The various broadcast transmissions may be received from a variety of content sources 301a-301g. Each of the transport streams may be inputted into a multiplexer 303 configured to multiplex streams 305a-305g into a single carrier transport stream 307 formatted according to a non-receiver compatible broadcast protocol such as DVB-T2/NGH. In one or more arrangements, the carrier transport stream protocol is different from the broadcast protocols of one or more of the multiplexed/tunneled streams 305a-305g. According to one or more aspects, each of multiplexed streams 305a-305g is carried through different physical layer pipes (PLPs) of carrier transport stream 307. A PLP, as used herein, generally refers to a channel providing allocated resources through which data for particular services or content may be transmitted in the physical layer (as defined in the Open Systems Interconnection (OSI) Reference Model). Each of multiplexed streams 305a-305g may include program specific information/service information (PSI/SI) defining the services provided. For example, the PSI/SI for stream 305a might indicate a service provider (e.g., a television broadcast provider) and a service type (e.g., FM radio, digital radio, digital television) for the content included therein. Additionally or alternatively, carrier stream 307 may include PSI/SI for services that are currently available or that will be available in the future.

Content servers 301a-301g may each include various components including a processor 309, random access memory (RAM) 311, read only memory (ROM) 313 and a database 315. Processor 309 may be configured to execute various instructions and to perform calculations for preparing and transmitting scalable video broadcasts. RAM 311 and ROM 313 may be configured to store instructions for execution or access by the processor 309. Database 315 may be used to store content, subscriber information, network information and the like.

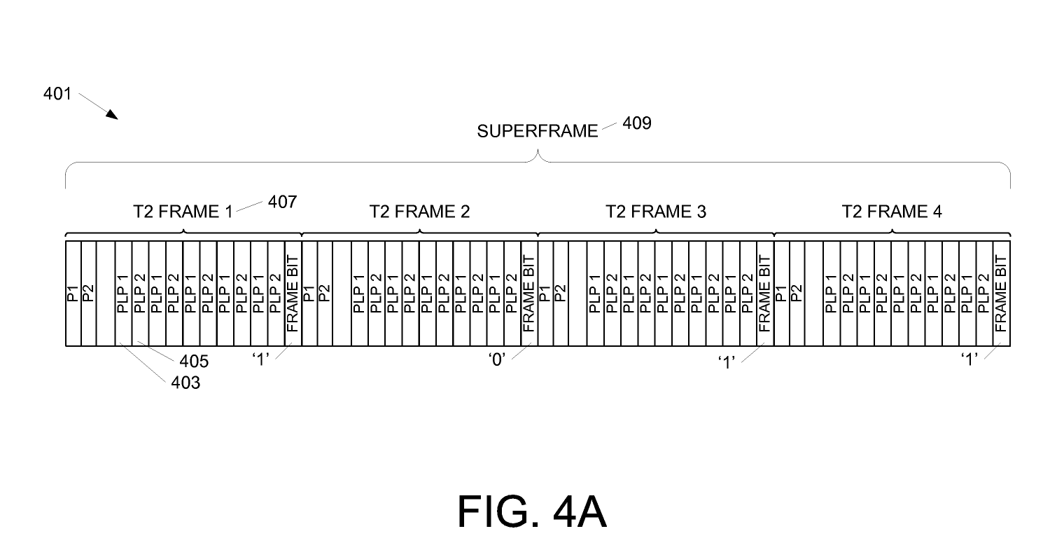

FIG. 4A illustrates an example DVB-T2 transport stream in which various services and streams may be tunneled using different PLPs. For example, PLP1 403 may be used to deliver a DVB-T transport stream while PLP2 405 may be used to carry a DVB-C transport stream. In order to identify each of the transport streams, signaling information may be provided in an L1 pre-signaling section of one or more frames such as frame 407 and superframe 409. A superframe denotes a series of X frames each ending in a framing bit, where X corresponds to a number of bits in a framing bit pattern formed by framing bits of X consecutive frames. The framing bit pattern is generally used to identify the end of each frame and to help a receiver align itself with the transmission. Accordingly, if a framing bit pattern is 4 bits long, a superframe comprises 4 frames. In the illustrated example, the framing bit pattern is 1011. Thus, if the receiver knows that each frame in a transport stream is 32 bits long, the receiver will look for the bits 1, 0, 1 and 1 spaced 32 bits apart from the preceding bit and in that particular order. This allows the receiver to align itself so that it is able to time its reception of frames appropriately.

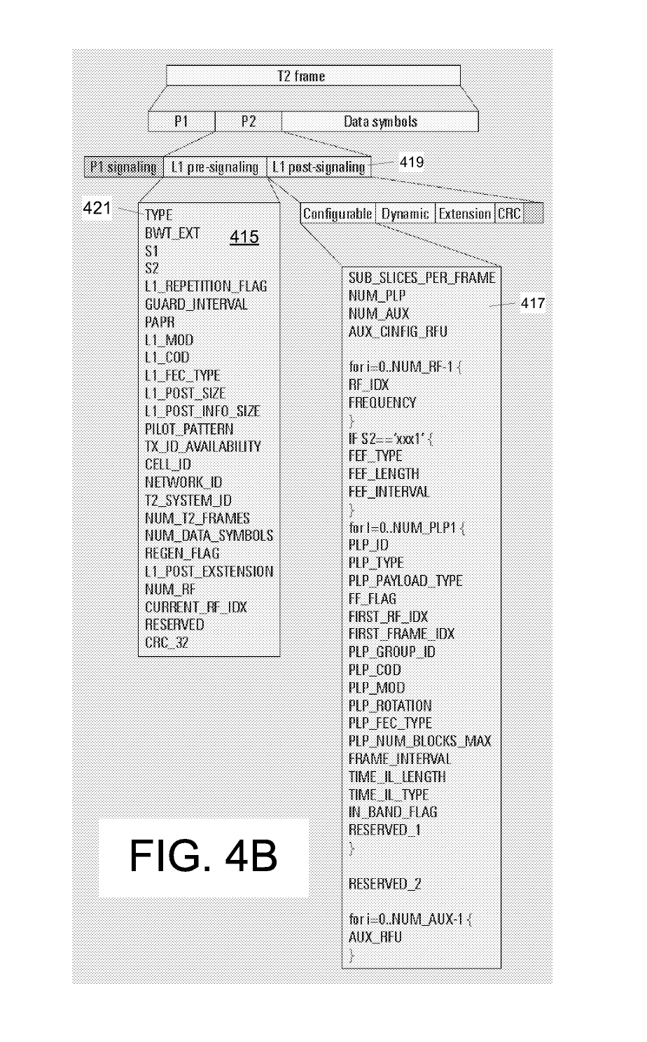

FIG. 4B illustrates an exemplary pre-signaling section and a post-signaling section of a transmission frame such as frame 407 of FIG. 4A. L1 pre-signaling carried in the P2 symbols may have a fixed size, coding and modulation, including basic information about the broadcast system as well as information needed to decode the L1-post signaling. The L1 pre-signaling may remain the same for the duration of a super-frame. L1-post signaling carried in the P2 symbol may carry more detailed L1 information about the broadcast system and the PLPs. ‘TYPE’ field 421 of L1 pre-signaling section 415 in pilot signal P2 may be defined according to the example table shown in FIG. 5, where the various types of transmissions are identified according to predefined values. Values may also be assigned for any combination of stream types. For example, a value of ‘8’ may be assigned for a stream carrying both DVB-T and DVB-S content while a value of ‘9’ may correspond to a stream carrying DVB-T, DVB-S and DVB-C content. Pilot signals P1 and P2 are generally defined to enable fast channel searching and service discovery within a frame. In particular, pilot signal P1 may be used to enable a fast initial scan for signals and to signal Fast Fourier Transform (FFT) size and frequency offsets to a receiver while pilot signal P2 may be used to define physical layer (L1) and frame specific information in addition to data link layer (L2) signaling. For example, L2 signaling may include program specific information/service information. Accordingly, by examining L1 pre-signaling section 415 and, in particular, ‘TYPE’ field 421, a receiver may recognize the types of broadcasts that are carried within stream 401 and determine whether to process those broadcasts. In some arrangements, the P1 and P2 signaling information may be defined for an entire superframe rather than a single frame (i.e., specifying types of broadcast transmissions across an entire superframe and not just the frame in which the P1 and P2 signaling information is carried).

Additionally, a receiver may identify the particular PLPs corresponding to each of the types of broadcasts carried in stream 401 using data specified in configurable portion 417 of L1 post-signaling section 419. As illustrated in FIG. 4A, configurable portion 417 may define a series of parameters and variables for each PLP, including PLP_PAYLOAD_TYPE. This parameter, PLP_PAYLOAD_TYPE, may be used to define the type of broadcast transmission that is carried in a corresponding PLP (e.g., identified by PLP_ID).

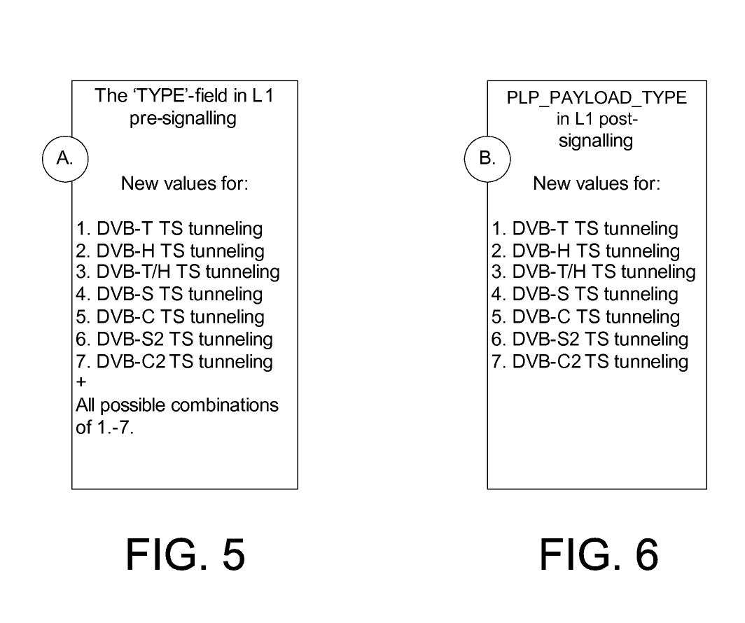

FIG. 6 illustrates an example table of values that may be used to define PLP_PAYLOAD_TYPE. According to the example table, a value of ‘1’ may correspond to a DVB-T transmission while a value of ‘4’ may correspond to a DVB-S transmission. Accordingly, by examining the PLP_PAYLOAD_TYPE of each PLP, a receiver may be able to identify and retrieve desired or compatible broadcast content. PLP_TYPE may be used to indicate availability of tunneled streams within a superframe.

By using both pre-signaling and post-signaling to identify the types of streams tunneled in a carrier transport stream such as stream 401, a receiver need not examine each PLP's data in a post-signaling section (e.g., section 419) to determine whether a compatible or desired transmission exists in stream 401. Instead, the receiver might only have to examine the pre-signaling information (e.g., in section 421) to make such a determination thereby resulting in more efficient processing. If the stream includes a compatible or desirable transmission, the receiver may then examine the individual PLPs to retrieve the content. Additionally, by indicating in the pre-signaling information that a stream includes tunneled transmissions, a receiver would know not to operate under the assumption that the post-signaling information and the stream only include data corresponding or formatted according to the broadcast protocol in which the stream was transmitted. For example, if tunneling information is not provided in the pre-signaling section in the case of DVB-T2, a receiver might assume that program specific information/service information (PSI/SI) is separated from a corresponding content stream, modified to include DVB-T2 specific signaling and at least partially carried in a common PLP. For tunneled transmissions, such assumptions may be inaccurate since PSI/SI might actually be carried within each content stream and might not include DVB-T2 specific signaling.

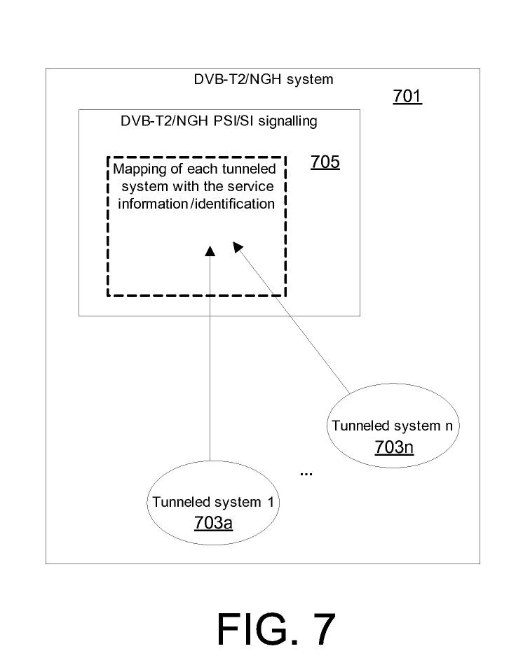

FIG. 7 is an exemplary block diagram of a PSI/SI mapping of multiple tunneled transmissions or systems to a DVB-T2 transport stream. The mapping may be provided by defining service information and identification for each of the tunneled transmissions 703a-703n in PSI/SI signaling portions 705 of carrier stream/system 701. In one or more configurations, the PSI/SI signaling portion 705 may be carried in a common PLP of the transport stream 701. A common PLP refers to a PLP carrying information that may apply to or supplement all transmissions, services or content carried therein. A common PLP may be designated as such by a corresponding value assigned to the PLP_PAYLOAD_TYPE (e.g., a value of ‘0’ may be used to designate common PLPs) of the PLP. In FIG. 4A, for example, PLP1 may be designated as a common PLP carrying network PSI/SI information for the transmission stream by setting its PLP_PAYLOAD_TYPE to a value of ‘0’.

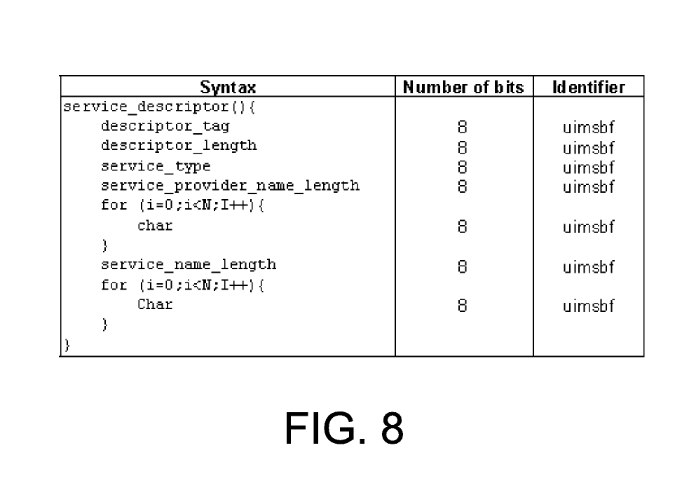

PSI/SI may be stored in a variety of ways. FIG. 8 illustrates one example where a service descriptor is used to define and store PSI/SI in a transport stream. The syntax of the service descriptor provides for a service type definition, a service provider name and a service name. The variables and parameters specified in the syntax are described as follows:

Descriptor_Tag: An 8-bit field which identifies each descriptor.

Descriptor_Length: An 8-bit field specifying the total number of bytes of the data portion of the descriptor following the byte defining the value of this field.

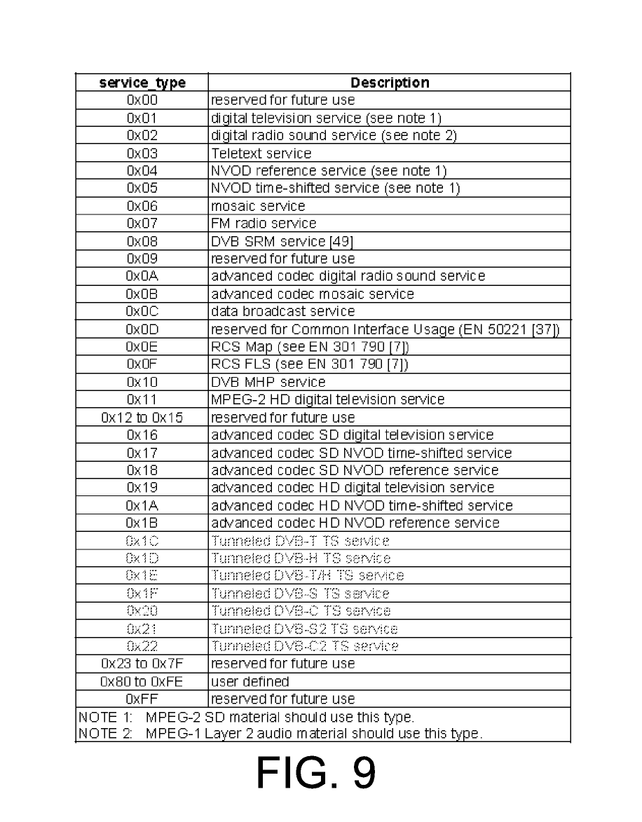

Service_Type: An 8-bit field specifying the type of service. Types of service may include digital television service, digital radio service, teletext service, DVB-T tunneled service, DVB-C tunneled service, DVB-C2 tunneled service and the like. A listing of service_types and corresponding values according to one or more aspects of the present disclosure is illustrated in FIG. 9.

Service_Provider_Name_Length: This 8-bit field specifies the number of bytes that follow the service_provider_name_length field for describing characters of the name of the service provider. A service provider's name may be, for example, YLE or CBS.

Service_Name_Length: This 8-bit field specifies the number of bytes that follow the service_name_length field for describing characters of the name of the service. An example of a service name may include “Television Show 1,” or “DVB-C services.”

Accordingly, not only is a receiver able to identify the particular PLPs corresponding to a tunneled service, it may also determine a service name and service provider name associated with the service. For example, a service provider name may correspond to the name of a content provider from which a tunneled DVB-C2 stream is received. Similarly, the service name may correspond to a channel name (e.g., “Channel 2”) or content package name (e.g., “Sports Content Package”). The service descriptors for each tunneled stream or service may be stored in a service description table (SDT) of the carrier transport stream.

According to one or more aspects, PSI/SI may include information for content or services that will be broadcast in future transmission frames and that might not be included in the present frame or superframe. By identifying future broadcast services and content, a content provider may notify a user of future programming in which the user may be interested. If the user is interested in a future broadcast, the receiver may examine a network information table to determine additional information about the broadcast such as a transport stream id of a transport stream carrying the broadcast, a broadcast time, whether the broadcast includes scalable content and the like. Such additional information may be defined using various parameters (e.g., transport_stream_id) and descriptors (e.g., advanced_scalable_video_codec descriptor) included in the network information table.

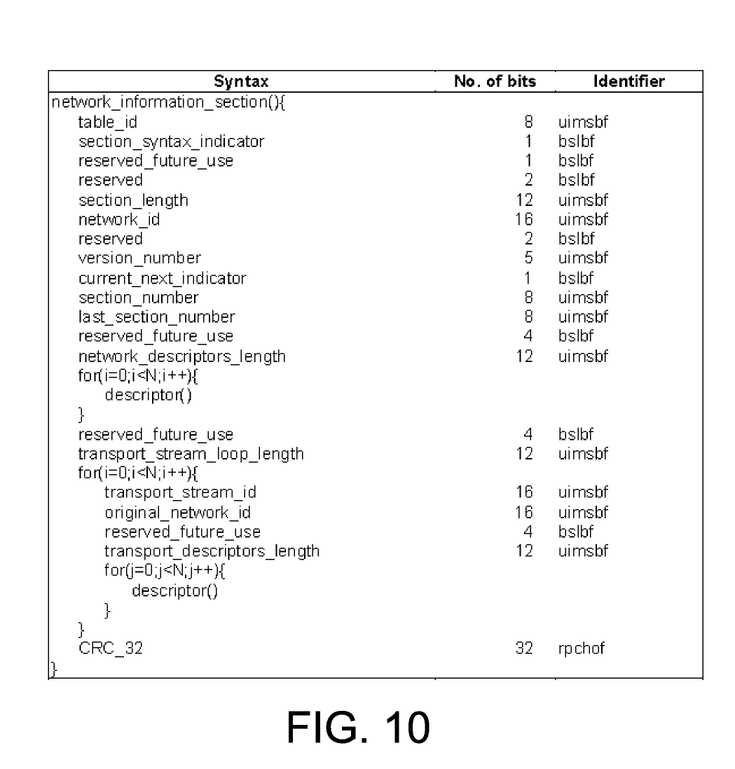

FIG. 10 illustrates an example syntax for a network information table. Service description tables and network information tables may both be carried in a common PLP of the underlying carrier transport stream.

PSI/SI carried within a common PLP may be specific to the carrier protocol, e.g., DVB-T2/NGH. In one or more arrangements, such PSI/SI (i.e., PSI/SI provided in the common PLP of the carrier stream) may require an operator to inspect incoming streams and configure PSI/SI carried within the common PLP in accordance with DVB-T2/NGH protocol. In contrast, when the stream is tunneled as ‘a whole’ through PLP, the operator might not need to inspect inside the stream and thus, the PSI/SI may remain unchanged (e.g., no configuration of the PSI/SI may be needed).

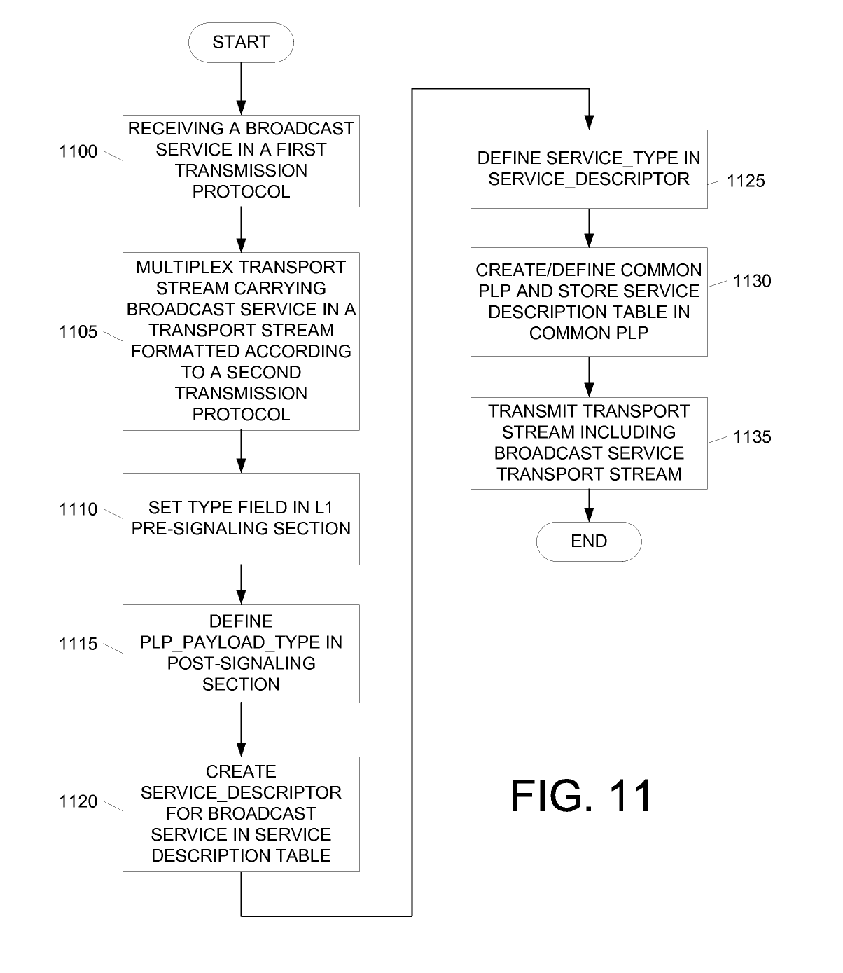

FIG. 11 is a flowchart illustrating an exemplary method by which a content provider may prepare and transmit a carrier DVB-T2 or a DVB-NGH transport stream in which one or more transport streams are tunneled. Alternatively or additionally, the carrier stream may include other types of data streams such as program streams, PES and the like. In step 1100, content provider may receive a broadcast service formatted according to a first transmission protocol. For example, the broadcast service may include digital video content encapsulated in a DVB-T transport stream. In step 1105, the broadcast service may multiplex the transport stream carrying the broadcast service with one or more other transport streams into a carrier transport stream that conforms to a second type of transmission protocol such as DVB-T2. For example, the broadcast service may allocate resources to create or define multiple PLPs, where each multiplexed or tunneled transport stream is assigned to one of the PLPs. In step 1110, the broadcast service may set a TYPE field in a L1 pre-signaling section of the transport stream indicating the type(s) of tunneled streams carried therein. For example, the type field may be assigned a value according to the table of FIG. 5. In step 1115, the broadcast service may further define a PLP_PAYLOAD_TYPE for the PLP corresponding to the tunneled transport stream in the post-signaling section to identify the transport stream type. In the example of a DVB-T transport stream, the PLP_PAYLOAD_TYPE may be assigned a value as specified in the table of FIG. 6.

In step 1120, the broadcast service may define PSI/SI by creating service descriptors for each of the tunneled streams. The service descriptors may be defined in a service description table stored in a common PLP of the carrier transport stream (i.e., the DVB-T2 transport stream). A service_type field of each service descriptor may further be assigned a value indicative of the transport protocol (e.g., DVB-T, DVB-C, DVB-S, etc.) in which the corresponding tunneled stream is formatted in step 1125. In one or more arrangements, a common PLP may also be defined for storage of data common to all services in step 1130 including the PSI/SI defined in the service descriptors. Upon defining the above parameters and variables of the transmission, the carrier DVB-T2 transport stream may be transmitted to one or more receiving devices in step 1135.

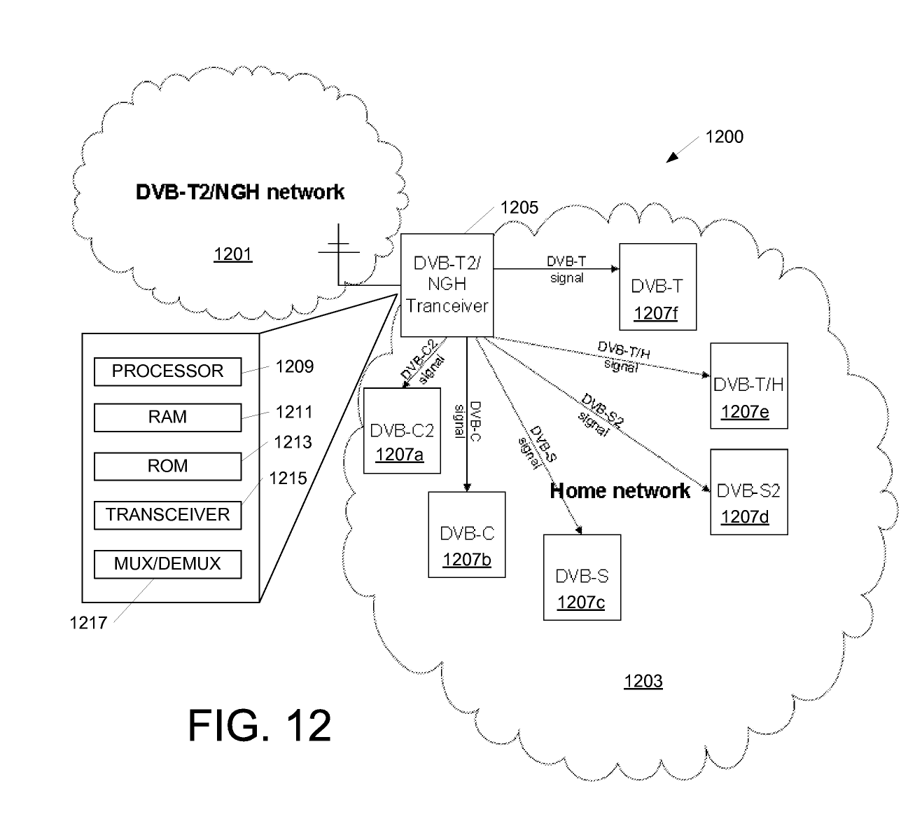

FIG. 12 illustrates a network through which a carrier transport stream may be processed and tunneled streams carried therein may be delivered to one or more appropriate devices. Network 1200 includes a broadcast network 1201 and a home or local network 1203. Broadcast network 1201 may include content sources and various transmission means through which digital broadcasts are transmitted. Home network 1203 may include a DVB-T2 transceiver 1205 and legacy broadcast receivers 1207a-1207f The DVB-T2 transceiver 1205 may be configured to receive a DVB-T2 transport stream carrying one or more tunneled streams such as DVB-T streams, DVB-C2 streams, DVB-S streams and the like using transceiver 1215. The transceiver 1205 may include a multiplexer/demultiplexer 1217 that is configured to extract each of the tunneled streams from the carrier transport stream. Once extracted and separated, processor 1209 of transceiver 1205 may be configured to determine a protocol type of each tunneled stream and deliver each stream to an appropriate one of receivers 1207a-1207f. For example, transceiver 1205 may determine which of receivers 1207a-1207f has the capability to render or process the various determined protocol types carried within the DVB-T2 transport stream. Transceiver 1205 may further include RAM 1211 and ROM 1213 for temporary and permanent storage of data, computer readable instructions and the like. Transceiver 1205 may further include storage (not shown) that is configured to store services, content, device profile information and the like.

In one or more examples, each of receivers 1207a-1207f may be registered with DVB-T2/NGH transceiver 1205 either manually (e.g., via user configuration and input) or automatically. If registration is performed manually, a user may provide address and other identification information of each of receivers 1207a-1207f to transceiver 1205. Alternatively or additionally, registration may include automatic detection of receivers 1207a-1207f and/or transceiver 1205 being connected to a network or directly to one or more of receivers 1207a-1207f. Transceiver 1205 may further automatically determine device capabilities by sending requests to each of receivers 1207a-1207f for capability information. Alternatively, receivers 1207a-1207f may automatically send such information upon detecting the presence of another receiver (e.g., transceiver 1205) being connected to network 1203.

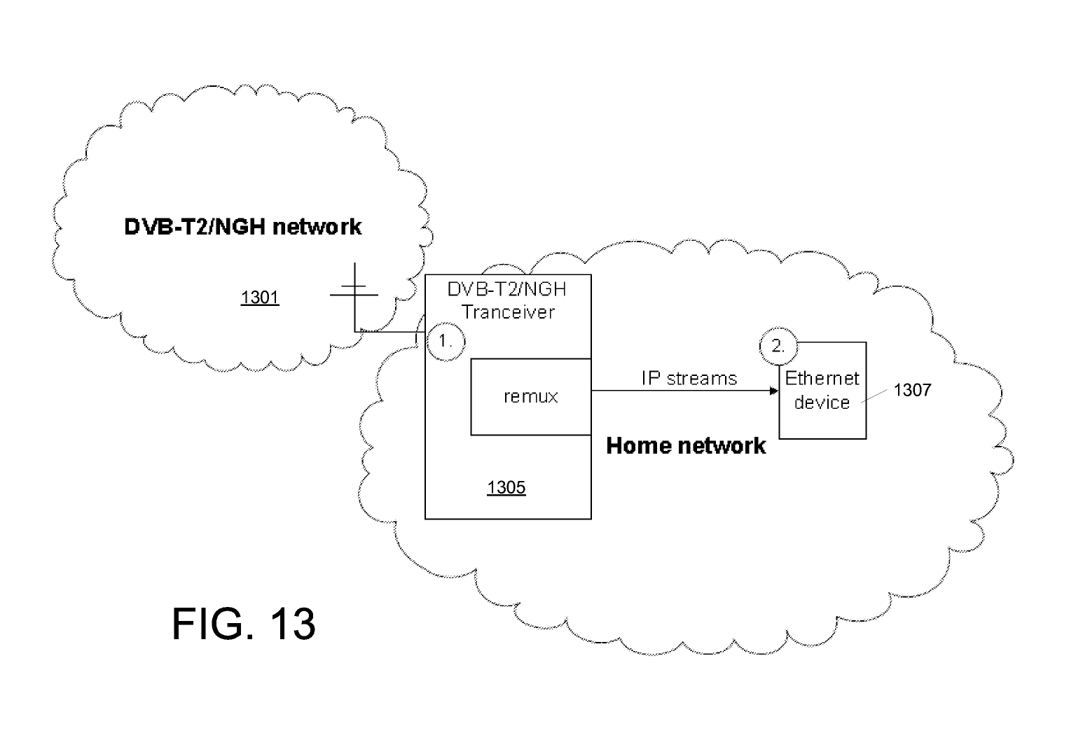

FIG. 13 illustrates a further embodiment where broadcast streams may be converted into and delivered via Internet Protocol (IP) data streams. In particular, DVB-T2/NGH transceiver 1305 may receive a DVB-T2 transport stream through broadcast network 1301, where the transport stream includes one or more tunneled streams. Upon receipt of the DVB-T2 transport stream, transceiver 1305 may demultiplex and de-encapsulate the tunneled streams from the transport stream) and re-encapulsate (e.g., multiplex and packetize) them according to IP. The IP packets or datagrams may then be transmitted to one or more IP-enabled devices such as device 1307 that is configured to receive IP data over an Ethernet connection.

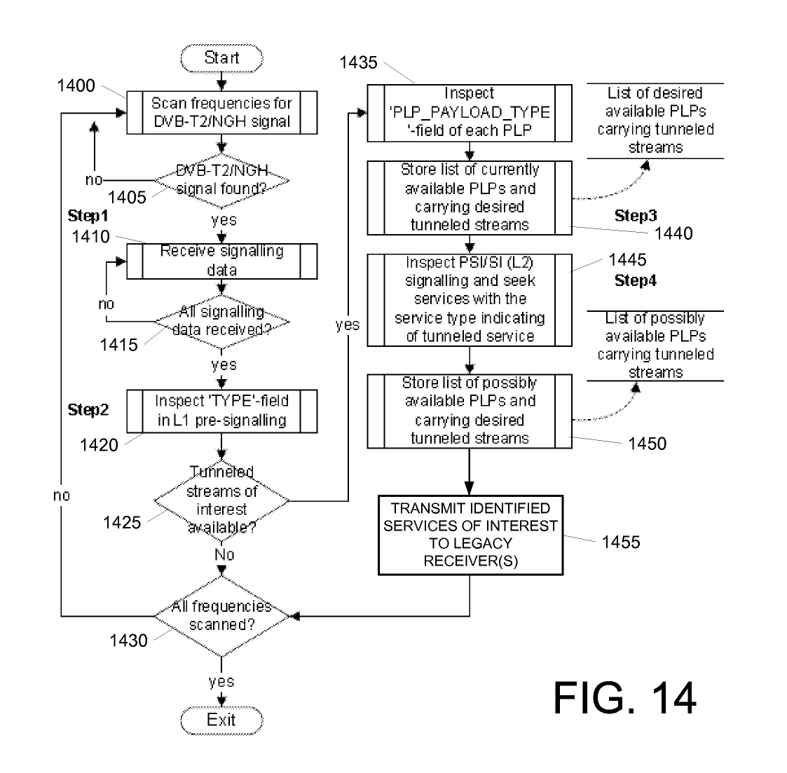

FIG. 14 illustrates an exemplary method by which a DVB-T2 transceiver may receive and process a DVB-T2 transport stream. In step 1400, the transceiver may scan frequencies to seek a DVB-T2/NGH signal. For example, the transceiver may use a tuner and modify the receiving parameters of the tuner to detect a DVB-T2/NGH signal. In step 1405, the transceiver may determine whether a DVB-T2/NGH signal is found. For example, DVB-T2 signals may be transmitted on particular frequencies and thus the transceiver may detect whether a signal exists on those frequencies. If a DVB-T2 signal is not found, the transceiver may continue to monitor and scan the various frequencies of a network. If, on the other hand, a DVB-T2/NGH signal is found, the transceiver may receive signaling data such as L1 pre- and post-signaling information in step 1410. In one example, the signaling data may be included in a transport stream carried in the DVB-T2/NGH signal. The receiver may determine whether all signaling data has been received in step 1415 and if not, continue to receive signaling data (step 1410). In one example, the signaling data within DVB-T2 may include dedicated symbols for identifying the start and end of the signaling data. Hence receiver may be able to determine when it has received all symbols/data.

Once all signaling data has been received, the transceiver may inspect a TYPE field in the L1 pre-signaling section of the signal in step 1420. In step 1425, the transceiver may determine whether there are any tunneled streams of interest signaled in the pre-signaling section. This determination may be made based on device or user profile information indicating the types of content that is compatible with a user's device. For example, the user may specify that his or her receiver is able to receive DVB-T and DVB-S streams but not DVB-C streams. If no streams of interest are identified from the signal, the transceiver may then determine if all frequencies have been scanned in step 1430. If not, the transceiver may return to step 1400 to continue scanning other frequencies for additional DVB-T2/NGH signals. If all frequencies have been scanned, the transceiver may exit the process.

If, however, there are streams of interest in the DVB-T2/NGH signal, the transceiver may subsequently inspect a PLP_PAYLOAD_TYPE of each PLP carried in the signal in step 1435. PLP parameters and specification may be stored in an L1 post-signaling section as described herein. In step 1440, a list of the PLPs corresponding to the streams of interest may be stored at the transceiver. The list of PLPs may include PLP_IDs of the PLPs of interest, a description of the content carried therein, the content itself and/or combinations thereof. Additionally, in step 1445, the transceiver may further inspect the PSI/SI in the signal to identify other services of interest. In one example, inspecting the PSI/SI of the signal may include the transceiver identifying services having service types matching the service type of the identified PLPs of interest. The service types may, for instance, be configured to specify types of tunneled streams using new service_type values as illustrated in the example embodiment of FIG. 9. In step 1450, a list of services of interest identified from the PSI/SI may further be stored. The PSI/SI may provide information not only for currently available services but also future services.

The transceiver may further transmit the identified currently available services of interest to one or more receivers having the capability to process the services provided in the PLPs in step 1455. In one example, the list of PLPs of interest may be identified or transmitted to the one or more receivers. The receivers may then request and receive various content streams based on the identified PLPs in the list and receiver compatibility. The process may then return to step 1430.

The above method may be used for any transceiver able to process a protocol to which a carrier transport stream having one or more tunneled streams conforms. Such protocols any currently existing or future protocols that facilitate the tunneling of streams within a carrier stream.

It should be understood that any of the method steps, procedures or functions described herein may be implemented using one or more processors in combination with executable instructions that cause the processors and other components to perform the method steps, procedures or functions. As used herein, the terms “processor” and “computer” whether used alone or in combination with executable instructions stored in a memory or other computer-readable storage medium should be understood to encompass any of various types of well-known computing structures including but not limited to one or more microprocessors, special-purpose computer chips, digital signal processors (DSPs), field-programmable gate arrays (FPGAS), controllers, application-specific integrated circuits (ASICS), combinations of hardware/firmware/software, or other special or general-purpose processing circuitry.

The methods and features recited herein may further be implemented through any number of computer readable media that are able to store computer readable instructions. Examples of computer readable media that may be used include RAM, ROM, EEPROM, flash memory or other memory technology, CD-ROM, DVD or other optical disk storage, magnetic cassettes, magnetic tape, magnetic storage and the like.

Additionally or alternatively, in at least some embodiments, the methods and features recited herein may be implemented through one or more integrated circuits (ICs). An integrated circuit may, for example, be a microprocessor that accesses programming instructions or other data stored in a read only memory (ROM). In some such embodiments, the ROM stores programming instructions that cause the IC to perform operations according to one or more of the methods described herein. In at least some other embodiments, one or more the methods described herein are hardwired into an IC. In other words, the IC is in such cases an application specific integrated circuit (ASIC) having gates and other logic dedicated to the calculations and other operations described herein. In still other embodiments, the IC may perform some operations based on execution of programming instructions read from ROM or RAM, with other operations hardwired into gates and other logic of IC. Further, the IC may output image data to a display buffer.

Although specific examples of carrying out the invention have been described, those skilled in the art will appreciate that there are numerous variations and permutations of the above-described systems and methods that are contained within the spirit and scope of the invention as set forth in the appended claims. Additionally, numerous other embodiments, modifications and variations within the scope and spirit of the appended claims will occur to persons of ordinary skill in the art from a review of this disclosure.

What is claimed is:

1. A method comprising:
receiving, at a broadcast receiver, a carrier stream conforming to a first broadcast protocol, wherein the carrier stream includes a tunneled data stream conforming to a second broadcast protocol;
determining, by the broadcast receiver, whether the carrier stream includes a stream of interest based on pre-signaling information of the carrier stream, wherein the stream of interest includes the tunneled data stream; and
in response to determining that the carrier stream includes the stream of interest, storing physical layer pipe information for the tunneled data stream.

2. The method of claim 1, wherein the first broadcast protocol comprises at least one of:
Digital Video Broadcast—Second Generation Terrestrial and Digital Video Broadcast—Next Generation Terrestrial.

3. The method of claim 1, wherein the second broadcast protocol comprises at least one of:
Digital Video Broadcast—Terrestrial, Digital Video Broadcast—Cable, Digital Video Broadcast—Second Generation Cable, Digital Video Broadcast—Satellite and Digital Video Broadcast—Second Generation Satellite.

4. The method of claim 1, wherein the storing the physical layer pipe information comprises storing a physical layer pipe identifier associated with the stream of interest and a description of the content carried in the stream of interest in the pre-signaling information of the carrier stream.

5. The method of claim 1, further comprising demultiplexing a plurality of tunneled data streams from the carrier stream, wherein each of the plurality of tunneled data streams is associated with a different physical layer pipe.

6. The method of claim 1, wherein the determining, by the broadcast receiver, whether the carrier stream includes the stream of interest comprises comparing a list of one or more protocols compatible with the broadcast receiver with one or more protocols specified in the pre-signaling section as being carried in the carrier stream.

7. The method of claim 1, further comprising extracting a tunneled data stream corresponding to a common physical layer pipe storing information common to multiple tunneled data streams.

8. The method of claim 7, further comprising extracting program specific information from the tunneled data stream of the common physical layer pipe.

9. A method comprising:
receiving, at a broadcast system, a first data stream conforming to a first broadcast protocol;
multiplexing, by the broadcast system, the first data stream into a carrier transport stream conforming to a second broadcast protocol;
assigning, by the broadcast system, the first data stream to a first physical layer pipe of the carrier transport stream; and
identifying, by the broadcast system, the second transport protocol in a pre-signaling section of the carrier transport stream.

10. The method of claim 9, wherein the multiplexing the first data stream into the carrier transport stream comprises tunneling the first data stream in the carrier transport stream.

11. The method of claim 9, further comprising storing an association of the first physical layer pipe with the first data stream in a post-signaling section of the carrier transport stream.

12. The method of claim 9, wherein the multiplexing the first data stream into the carrier transport stream comprises multiplexing the first data stream with a second data stream, wherein the second data stream conforms to a third broadcast protocol and wherein the method further comprises:
assigning the second data stream to a second physical layer pipe.

13. The method of claim 12, further comprising designating the second physical layer pipe as a common physical layer pipe storing information common to multiple physical layer pipes of the carrier transport stream.

14. The method of claim 13, further comprising storing program specific information in the common physical layer pipe.

15. An apparatus comprising:
at least one processor; and
at least one memory operatively coupled to the processor and storing computer readable instructions that, when executed, cause the apparatus to:
receive a carrier stream conforming to a first broadcast protocol, wherein the carrier stream includes a tunneled data stream conforming to a second broadcast protocol;
determine whether the carrier stream includes a stream of interest based on pre-signaling information of the carrier stream, wherein the stream of interest includes the tunneled data stream; and
in response to determining that the carrier stream includes the stream of interest, storing physical layer pipe information for the tunneled data stream.

16. The apparatus of claim 15, wherein the computer readable instructions, when executed, further cause the apparatus to demultiplex a plurality of tunneled data streams from the carrier stream, wherein each of the plurality of tunneled data streams is associated with a different physical layer pipe.

17. The apparatus of claim 15, wherein determining whether the carrier stream includes the stream of interest includes comparing a list of one or more protocols compatible with the broadcast receiver with one or more protocols specified in the pre-signaling section as being carried in the carrier stream.

18. An apparatus comprising:
at least one processor; and
at least one memory operatively coupled to the processor and storing computer readable instructions that, when executed, cause the apparatus to:
receive a first data stream conforming to a first broadcast protocol;
multiplex the first data stream into a carrier transport stream conforming to a second broadcast protocol;
assign the first data stream to a first physical layer pipe of the carrier transport stream; and
identify the second transport protocol in a pre-signaling section of the carrier transport stream.

19. The apparatus of claim 18, wherein multiplexing the first data stream into the carrier transport stream includes multiplexing the first data stream with a second data stream, wherein the second data stream conforms to a third broadcast protocol and
wherein the computer readable instructions, when executed, further cause the apparatus to assign the second data stream to a second physical layer pipe.

20. The apparatus of claim 18, wherein the computer readable instructions, when executed, further cause the apparatus to designate the second physical layer pipe as a common physical layer pipe storing information common to multiple physical layer pipes of the carrier transport stream.

21. One or more non-transitory computer readable media storing computer readable instructions that, when executed, cause an apparatus to:
receive a carrier stream conforming to a first broadcast protocol, wherein the carrier stream includes a tunneled data stream conforming to a second broadcast protocol;
determine whether the carrier stream includes a stream of interest based on pre-signaling information of the carrier stream, wherein the stream of interest includes the tunneled data stream; and
in response to determining that the carrier stream includes the stream of interest, storing physical layer pipe information for the tunneled data stream.
